(19) United States
(12) Patent Application Publication
(10) Pub. No.: US 2019/0171955 A1
(43) Pub. Date: Jun. 6, 2019

(54) SYSTEM AND METHOD FOR INFERRING ANONYMIZED PUBLISHERS

(71) Applicant: Cognant LLC, Mountain View, CA (US)

(72) Inventors: Bhargav Bhushanam, Mountain View, CA (US); Heng Wang, San Jose, CA (US); Daniel Gelman, Palo Alto, CA (US); Ishan Upadhyaya, San Carlos, CA (US); James Koh, Mountain View, CA (US)

(21) Appl. No.: 16/180,261

(22) Filed: Nov. 5, 2018

Related U.S. Application Data
(60) Provisional application No. 62/595,230, filed on Dec. 6, 2017.

(51) Int. Cl. G06N 5/04

(52) U.S. Cl. CPC G06N 5/048; H04L 67/42

(57) ABSTRACT

A method, a system, and an article are provided for inferring the identifies of publishers of online digital content. An example method can include: obtaining data including a history of content presentations by a plurality of publishers on a plurality of client devices, the data providing an unambiguous identification of each publisher in a first portion of the publishers and an anonymous identification of each publisher in a second portion of the publishers; identifying a pair of publishers including a first publisher from the first portion and a second publisher from the second portion; calculating, based on the data, a similarity metric for the pair of publishers; and based on the calculated similarity metric, facilitating an adjustment of content presentations by the plurality of publishers.

### CROSS-REFERENCE TO RELATED APPLICATIONS

This application claims the benefit of U.S. Provisional Patent Application No. 62/595,230, filed Dec. 6, 2017, the entire contents of which are incorporated by reference herein.

### BACKGROUND

The present disclosure relates generally to the presentation of digital content by publishers and, in certain examples, to systems and methods for determining the identities of anonymized publishers.

In general, client devices are capable of presenting a wide variety of content, including images, video, audio, and combinations thereof. Such content can be stored locally on client devices and/or can be sent to the client devices from server computers over a network (e.g., the Internet). To watch an online movie, for example, a user of a client device can download a copy of the movie and/or can stream the movie from a content provider. Online content can be provided to client devices by publishers, such as websites and software applications.

Users can interact with content in various ways. A user can, for example, view images, listen to music, or play computer games. With certain online content, a user can select the content or a portion thereof and be directed to a website where further content can be presented or obtained. In some instances, users can download or receive content in the form of software applications.

### SUMMARY

In general, the subject matter of this disclosure relates to systems and methods for determining the identities of unknown publishers of online digital content. The systems and methods can begin by obtaining data representing a history of content presentations by a group of publishers on a plurality of client devices. The data provides an unambiguous identification of each publisher in a first portion of the publishers and an anonymous identification of each publisher in a second portion of the publishers. The publishers in the first portion can be referred to herein as “known” publishers, while the publishers from the second portion can be referred to herein as “unknown” publishers. A pair of publishers is identified that includes a known publisher and an unknown publisher, and a similarity metric is calculated for the pair of publishers. The similarity metric can provide an indication of a degree of overlap between the publishers for at least one parameter in the data. For example, the similarity metric can provide an indication how similar client device identifiers (or other parameter values) are in the history of content presentations for the two publishers. Future content presentations can be adjusted according to the calculated similarity metric.

Advantageously, the systems and methods are able to accurately and efficiently determine the identities of publishers that would otherwise remain anonymous. By identifying such publishers, the systems and methods can allow content developers and content providers to have a more accurate understanding of the publishers being used to distribute content. For example, when a known publisher and an unknown publisher are revealed to be the same, a content developer may choose to decrease usage of the publisher. This can result in a more efficient use of publishers for reaching a desired audience of users.

In one aspect, the subject matter described in this specification relates to a method. The method includes: obtaining data including a history of content presentations by a plurality of publishers on a plurality of client devices, the data providing an unambiguous identification of each publisher in a first portion of the publishers and an anonymous identification of each publisher in a second portion of the publishers; identifying a pair of publishers including a first publisher from the first portion and a second publisher from the second portion; calculating, based on the data, a similarity metric for the pair of publishers; and facilitating, based on the calculated similarity metric, an adjustment of content presentations by the plurality of publishers.

In certain examples, the data includes a client device identifier and a timestamp for each content presentation. Each publisher can be or include a website and/or a software application. The unambiguous identification can include a publisher name. The anonymous identification can include an anonymized publisher identifier. Calculating the similarity metric can include determining a degree of overlap between the first publisher and the second publisher for at least one parameter. Additionally or alternatively, calculating the similarity metric can include: calculating a plurality of similarity metrics by determining a degree of overlap between the first publisher and the second publisher for each parameter from a plurality of parameters; determining a weight for each calculated similarity metric; and weighing each similarity metric according to the determined weights.

In some implementations, calculating the similarity metric can include: calculating a corresponding similarity metric for two publishers from the first portion of publishers; determining a threshold value based on the corresponding similarity metric; and comparing the similarity metric for the pair of publishers with the threshold value. Calculating the similarity metric can include: determining, based on the similarity metric, that the first and second publishers are identical. The method can include: calculating a corresponding similarity metric for two publishers from the second portion of publishers, wherein the facilitated adjustment is based at least in part on the corresponding similarity metric.

In another aspect, the subject matter described in this specification relates to a system having one or more computer processors programmed to perform operations including: obtaining data including a history of content presentations by a plurality of publishers on a plurality of client devices, the data providing an unambiguous identification of each publisher in a first portion of the publishers and an anonymous identification of each publisher in a second portion of the publishers; identifying a pair of publishers including a first publisher from the first portion and a second publisher from the second portion; calculating, based on the data, a similarity metric for the pair of publishers; and facilitating, based on the calculated similarity metric, an adjustment of content presentations by the plurality of publishers.

In certain instances, the data includes a client device identifier and a timestamp for each content presentation. Each publisher can be or include a website and/or a software application. The unambiguous identification can include a publisher name. The anonymous identification can include an anonymized publisher identifier. Calculating the similarity metric can include determining a degree of overlap between the first publisher and the second publisher for at least one parameter. Additionally or alternatively, calculating the similarity metric can include: calculating a plurality of similarity metrics by determining a degree of overlap between the first publisher and the second publisher for each parameter from a plurality of parameters; determining a weight for each calculated similarity metric; and weighing each similarity metric according to the determined weights.

In some examples, calculating the similarity metric can include: calculating a corresponding similarity metric for two publishers from the first portion of publishers; determining a threshold value based on the corresponding similarity metric; and comparing the similarity metric for the pair of publishers with the threshold value. Calculating the similarity metric can include: determining, based on the similarity metric, that the first and second publishers are identical. The operations can include: calculating a corresponding similarity metric for two publishers from the second portion of publishers, wherein the facilitated adjustment is based at least in part on the corresponding similarity metric.

In another aspect, the subject matter described in this specification relates to an article. The article includes a non-transitory computer-readable medium having instructions stored thereon that, when executed by one or more computer processors, cause the computer processors to perform operations including: obtaining data including a history of content presentations by a plurality of publishers on a plurality of client devices, the data providing an unambiguous identification of each publisher in a first portion of the publishers and an anonymous identification of each publisher in a second portion of the publishers; identifying a pair of publishers including a first publisher from the first portion and a second publisher from the second portion; calculating, based on the data, a similarity metric for the pair of publishers; and facilitating, based on the calculated similarity metric, an adjustment of content presentations by the plurality of publishers.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for inferring anonymized publishers and managing digital content presentations.

FIG. 2 is a schematic data flow diagram of an example system for inferring anonymized publishers and managing digital content presentations.

FIG. 3 is a flowchart of an example method of inferring anonymized publishers and managing digital content presentations.

### DETAILED DESCRIPTION

In general, the subject matter of this disclosure relates to a system and method for determining the identities of publishers (e.g., websites and software applications) that present digital content on client devices. In a typical example, the system and method can collect or obtain data related to each content presentation. The data can be or include a record or history of the content presentations and can identify, for example, a client device, a publisher name or identifier, a presentation time, and/or a user interaction time for each presentation. Other types of information for the content presentations can be included in the data.

In various instances, the data for each content presentation can provide either (i) a clear or unambiguous identification of the publisher or (ii) an anonymized identification of the publisher. The unambiguous identification can include, for example, a name of the publisher or some derivation of the name that reveals the identity of the publisher. The anonymized identification can include, for example, a code or publisher identifier that, without more, does not reveal the identity of the publisher.

In a typical example, it is desirable to know the identities of the publishers presenting digital content on client devices. Such information can be used, for example, to ensure that content is being presented efficiently and/or with little or no waste of resources. In some instances, a content developer or provider may wish to provide content to a group of users. The content developer may make arrangements to use a group of publishers to provide the content to the users. When a portion of the publishers are anonymous or otherwise not identified to the content developer, however, it can be difficult for the content developer to achieve a desired distribution of the content. For example, an anonymous or unknown publisher in the group may in reality be the same as an identified or known publisher in the group, and this can result in an overuse of that publisher and/or redundant content presentations.

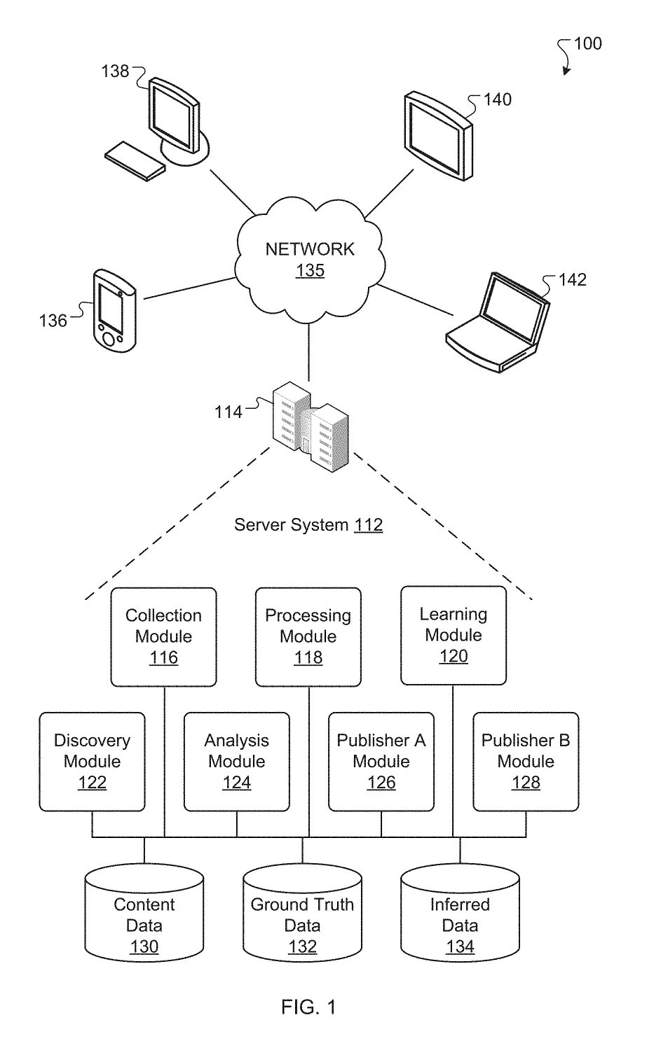

FIG. 1 illustrates an example system 100 for inferring anonymized publishers and managing digital content presentations. A server system 112 provides functionality for collecting, processing, and analyzing data associated with digital content presentations. The server system 112 includes software components and databases that can be deployed at one or more data centers 114 in one or more geographic locations, for example. In certain instances, the server system 112 is, includes, or utilizes a content delivery network (CDN). The server system 112 software components can include a collection module 116, a processing module 118, a learning module 120, a discovery module 122, an analysis module 124, a publisher A module 126, and a publisher B module 128. The software components can include subcomponents that can execute on the same or on different individual data processing apparatus. The server system 112 databases can include a content data 130 database, a ground truth data 132 database, and an inferred data 134 database. The databases can reside in one or more physical storage systems. The software components and data will be further described below.

An application, such as, for example, a web-based application, can be provided as an end-user application to allow users to interact with the server system 112. The client application or components thereof can be accessed through a network 135 (e.g., the Internet) by users of client devices, such as a smart phone 136, a personal computer 138, a tablet computer 140, and a laptop computer 142. Other client devices are possible. In alternative examples, the content data 130 database, the ground truth data 132 database, the inferred data 134 database, or any portions thereof can be stored on one or more client devices. Additionally or alternatively, software components for the system 100 (e.g., the collection module 116, the processing module 118, the learning module 120, the discovery module 122, the analysis module 124, the publisher A module 126, and the publisher B module 128) or any portions thereof can reside on or be used to perform operations on one or more client devices.

FIG. 1 depicts the collection module 116, the processing module 118, the learning module 120, the discovery module 122, the analysis module 124, the publisher A module 126, and the publisher B module 128 as being able to communicate with the content data 130 database, the ground truth data 132 database, and the inferred data 134 database. The content data 130 database generally includes digital content that can be presented on the client devices and/or a history or record of such digital content presentations. The digital content can be or include, for example, images, videos, audio, computer games, text, messages, offers, and any combination thereof. The history of content presentations can be or include, for example, data summarizing each content presentation and any user interactions with the content presentations. Such data can include, for example, a device identifier, a publisher name and/or publisher identifier, a timestamp for a presentation time, a timestamp for a user interaction time, and/or similar data for each content presentation. The ground truth data 132 database generally includes information related to content presentations provided by publishers that are known or unambiguously identified in the content data 130 database. Such information can be or include, for example, the history or record of each content presentation provided by the known or identified publishers. The inferred data 134 database generally includes information related to publishers that were previously anonymous but were later inferred or identified using the system 100. For example, the inferred data 134 database can provide a mapping of any anonymous publisher identifiers (e.g., present in the content data 130) to clear or unambiguous publisher identifiers.

In general, digital content (e.g., from the content data 130 database) can be presented on the client devices using a plurality of publishers, which can include the publisher A module 126 and the publisher B module 128. Any suitable number of publishers and publisher modules are possible. Each publisher can be or include, for example, a website and/or a software application configured to present the content. When an item of content is presented on a client device, the user can interact with the content in multiple ways. For example, the user can view the content, select or click one or more portions of the content, play a game associated with the content, and/or take an action associated with the content. In certain instances, the action can be or include, for example, watching a video, viewing one or more images, selecting an item (e.g., a link) in the content, playing a game, visiting a website, downloading additional content (e.g., a software application), and/or installing or using a software application. In some instances, the content can offer the user a reward in exchange for taking the action. The reward can be or include, for example, a credit to an account, a virtual item or object for an online computer game, free content, or a free software application. Other types of rewards are possible.

Additionally or alternatively, in some instances, the publishers can be rewarded based on actions taken by users in response to the presented content. For example, when a user clicks or selects an item of content or takes a certain action in response to the content, the publisher can receive a reward or compensation from an entity (e.g., a person or a company) associated with the content or the action. The reward or compensation can provide an incentive for the publisher to display the content.

In some instances, for example, a publisher can receive compensation when it presents an item of content on a client device and a user installs a software application (or takes a different action) in response to the content. The publisher can provide information to the collection module 116 indicating that the content was presented on the client device. Alternatively or additionally, the collection module 116 can receive an indication that the user selected the content and/or that the software application was installed. Based on the received information, the collection module 116 can attribute the software application installation to the item of content presented by the publisher. The publisher can receive the compensation based on this attribution.

In various examples, the collection module 116 can be or include an attribution service provider. The attribution service provider can receive data or information from publishers related to the presentation of content and user actions in response to the content. The attribution service provider can determine, based on the information received, how to attribute the user actions to individual publishers. In some instances, for example, a user can visit or use websites or software applications provided by publishers that present an item of content at different times on the user's client device. When the user takes an action (e.g., installs a software application) in response to the content presentations, the attribution service provider may select one of the publishers to receive the credit or attribution for the action. The selected publisher may be, for example, the publisher that was last to present content or to receive a click on content before the user took the action. The selected publisher can receive compensation from an entity associated with the content or the action. Other publishers that presented content and/or received clicks on content may receive no such compensation.

In a typical implementation, the data obtained by the collection module 116 can be or include a record of each content presentation on the client devices. Referring to Table 1, for example, the record for a content presentation can include a publisher identifier or ID, a device identifier or ID, an Internet Protocol (IP) address, a user agent, a timestamp, and, in some instances, a publisher name or other unambiguous publisher identification. The publisher ID is generally an anonymized combination of letters, numbers, and/or other symbols used to represent a publisher without revealing the identity of the publisher. The device ID is generally a combination of letters, numbers, and/or other symbols used to identify a particular client device. The IP address can be a numerical label that identifies a host computer to which a client device was connected during the content presentation. In some examples, the IP address can identify a location of the host computer. The user agent can identify a browser, a mobile device type or model (e.g., iPhone 7), and other information specific to the user or client device. The IP address in combination with the user agent (or a portion thereof) can be referred to as a “fingerprint” and can be useful for identifying specific users of the client devices. The timestamp can be a date and/or time when the content presentation occurred. The publisher name is generally an actual name of a publisher or some derivative thereof. When included in a record, the publisher name can provide an unambiguous identification of the publisher for that record. In the example data shown in Table 1, only three of the records include the publisher name. The remaining records include a publisher ID but no publisher name and are considered to be anonymized.

TABLE 1
Example history of content presentations on client devices.

| Publisher | Device | | User | Time- | Publisher |
|---|---|---|---|---|---|
| ID | ID | IP Address | Agent | stamp | Name |
| Abc | 123 | 123.456.789.123 | XYZ | Time 1 | |
| Def | 123 | 123.456.789.123 | XYZ | Time 2 | A |
| Ghi | 456 | 456.789.123.456 | ZYX | Time 3 | A |
| Jkl | 789 | 456.789.123.456 | YYZ | Time 4 | |
| Mno | 123 | 123.456.789.123 | ZYX | Time 5 | |
| Pqr | 789 | 456.789.123.456 | YYZ | Time 6 | B |
| Stu | 456 | 123.456.789.123 | ZYX | Time 7 | |

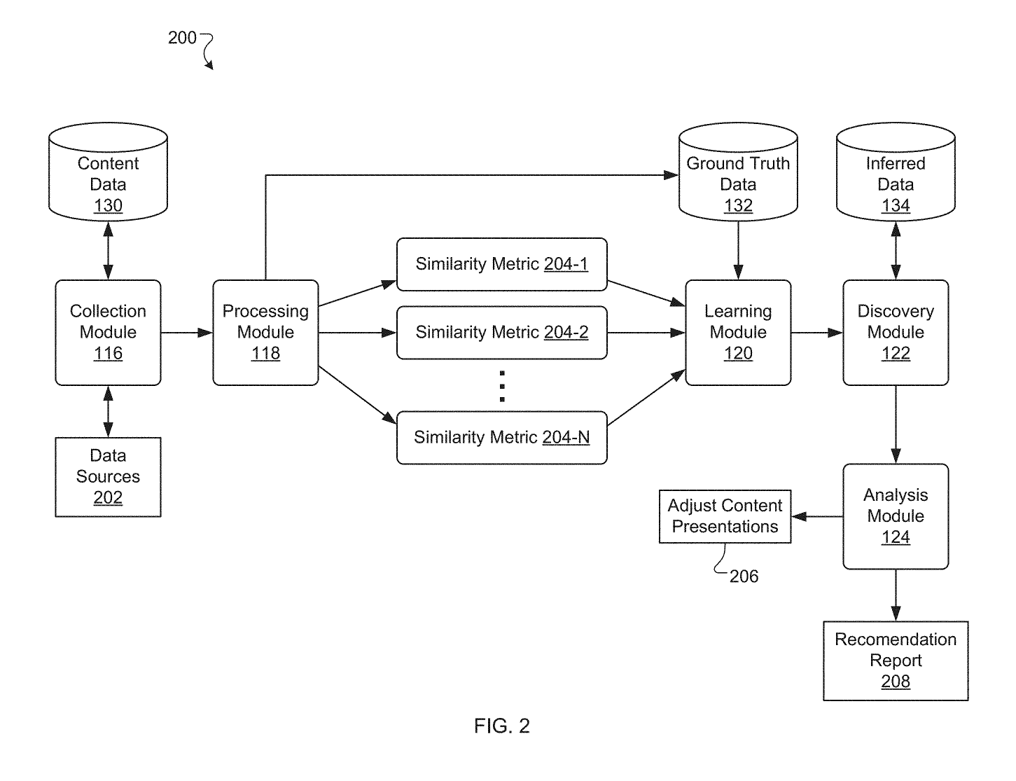

FIG. 2 includes a data flow diagram 200 illustrating an example in which the collection module 116, the processing module 118, the learning module 120, the discovery module 122, and the analysis module 124 can use statistical similarity metrics to infer a true publisher identity from anonymized publisher IDs. To begin, the collection module 116 receives content presentation data (e.g., as shown in Table 1) from data sources 202, such as publishers, content presentation partners, or other entities. The collection module 116 can store the content presentation data in the content data 130 database.

Next, the processing module 118 can process the data and perform various calculations based on the data, in preparation for subsequent analysis by other system components. For example, the processing module 118 can perform data cleansing to compensate for any missing or inaccurate data and/or can aggregate or sort the data (e.g., by publisher ID). The processing module 118 can then calculate various statistical similarity metrics that can be used to determine similarities between or among publishers. For example, the processing module 118 can calculate a similarity metric for a pair of publishers using the following equation (1):

$$similarity metric = \frac{{X}_{1} ⋂ {X}_{2}}{min ( \vert {X}_{1} \vert , \vert {X}_{2} \vert )} , \qquad ( 1 )$$

where X₁ is a set of parameter values for a first publisher, X₂ is a set of parameter values for a second publisher, ∩ refers to an overlap or intersection between X₁ and X₂, and min(|X₁|,|X₂|) is a minimum of (i) the number of values in the set X₁ and (ii) the number of values in the set X₂. For example, if the set X₁ and the set X₂ have 5 values in common, the set X₁ has a total of 10 values, and the set X₂ has a total of 12 values, then X₁∩X₂ is equal to 5, min(|X₁|,|X₂|) is equal to 10, and the similarity metric from equation (1) is 0.5. Other ways of calculating the similarity metric are possible. For example, the denominator in equation (1) could be replaced with max(|X₁|,|X₂|) or avg(|X₁|,|X₂|), where max(|X₁|,|X₂|) is the maximum of the number of values in the set X₁ and the number of values in the set X₂, and avg(|X₁|,|X₂|) is the average of the number of values in the set X₁ and the number of values in the set X₂. The similarity metric calculated using equation (1) can vary from 0 (when the similarity is low) to 1 (when the similarity is high). In general, the similarity metric can provide an indication of a degree of overlap in the parameter between the first publisher and the second publisher.

In some examples, the processing module 118 can calculate a similarity metric for a pair of publishers using the following equation (2):

$$similarity metric = \frac{{\sum }_{i = 1}^{N} {X}_{1 , i}^{′} {X}_{2 , i}^{′}}{\sqrt{{\sum }_{i = 1}^{N} {X}_{1 , i}^{′2}} \sqrt{{\sum }_{i = 1}^{N} {X}_{2 , i}^{′2}}} , \qquad ( 2 )$$

where X₁ is a vector of parameter values for a first publisher, X₂ is a vector of parameter values for a second publisher, and X′₁ and X′₂ represent normalized vectors of X₁ and X₂, respectively, such that X′₁ and X′₂ have values in the range [0,1] for each index of the vectors. Normalization can be done according to the following equation (3):

$${X}^{′} = \frac{X - min ( X )}{max ( X ) - min ( X )} . \qquad ( 3 )$$

In general, the similarity metric calculated using equation (2) represents a cosine of an angle formed by the two normalized vectors X′₁ and X′₂. The similarity metric calculated using this approach can vary from 0 to 1, with 0 representing low similarity and 1 representing high similarity.

The parameter used to calculate the similarity metric can be any parameter or combination of parameters included in or derived from the data obtained by the collection module 116. The parameter can be, for example, device ID, IP address, user agent, device model, fingerprint, timestamp, a limited ad tracking (LAT) client device setting, a level of user engagement with a software application (e.g., a software application installed in response to content presentations), a click through rate (e.g., a percentage of content presentations that were clicked or selected by users), a click-to-install ratio (e.g., a percentage of users who installed a software application after clicking on related content), or any combination thereof. When the parameter is device ID, for example, the similarity metric for a first publisher and a second publisher can be determined using equation (1), in which X₁ is a set of device IDs for the first publisher and X₂ is a set of device IDs for the second publisher. The greater the degree of overlap in device IDs for the two publishers, the greater the similarity in device IDs between the two publishers and the greater the similarity metric. Additional similarity metrics, calculated using other parameters, can provide an indication of how similar the two publishers are for the other parameters.

In preferred examples, the processing module 118 can calculate multiple similarity metrics for any combination of two publishers, and each similarity metric can be based on a different parameter or combination of parameters. For one pair of publishers, for example, a first similarity metric 204-1 can be based on device ID, a second similarity metric 204-2 can be based on IP address, and so on, up to an Nth similarity metric 204-N, which can be based on any remaining parameter or combination of parameters. N in this case can be any integer greater than or equal to 1. Additionally or alternatively, when using a combination of similarity metrics to compare two publishers, the similarity metrics can be weighted according to an expected significance. For example, if the similarity metric based on device ID is expected to provide a more significant signal than the similarity metric based on IP address, a combination of the two similarity metrics can be weighted more heavily in favor of the similarity metric based on device ID. The combination can be, for example, a weighted average in which a respective weight is assigned to each similarity metric. This way, more important similarity metrics can have a greater influence on the publisher comparison. The learning module 120 can be used to determine and/or apply appropriate weights to the similarity metrics.

In general, when calculating similarity metrics for a pair of publishers, one of the publishers can be a known publisher (e.g., unambiguously identified in the content data 130) and the other publisher can be an unknown or anonymous publisher. For such a pair, a goal of the similarity analysis can be to determine a likelihood that the two publishers are identical. If the likelihood is high (e.g., exceeds a threshold), then the two publishers can be considered to be the same, and the identity of the unknown or anonymous publisher can be inferred from the identity of the known publisher. In other examples, similarity metrics can be calculated for two known publishers. Such similarity metrics can provide threshold values as described herein. Additionally or alternatively, similarity metrics can be calculated for two unknown publishers. Such similarity metrics can be used to determine if the two unknown publishers are identical, without necessarily revealing the identities of the publishers. In some instances, similarity metrics can be calculated for all possible pairs of publisher IDs.

Still referring to FIG. 2, the calculated similarity metrics can be provided to the learning module 120, which can use available ground truth mappings data (e.g., from the ground truth data 132 database) and the calculated similarity metrics to learn or determine an ensemble of thresholds. In general, each similarity metric (e.g., for each parameter) can have its own threshold. The thresholds can provide a statistically significant level of confidence that two publisher IDs are for the same publisher. For example, when a similarity metric for a known publisher and an unknown publisher exceeds a determined threshold, the known publisher and the unknown publisher can be considered to be the same. In this way, the similarity metric and the threshold can be used to infer the identity of the unknown publisher. In some instances, a threshold for a similarity metric can be a value or a percentage. For example, threshold values of 0.25, 0.4, and 0.5 can provide statistical confidence levels of 75%, 90%, and 95%, respectively, that two publishers are the same.

To learn the thresholds, the learning module 120 can calculate similarity metrics for combinations of publishers that are known to be the same. For example, when two publisher IDs are associated with the same publisher, similarity metrics can be calculated for the two publisher IDs across a wide range of parameters. The resulting values can serve as thresholds when comparing other combinations of publishers that are not known to be the same. In general, threshold values are preferably determined using a most recent set of data obtained by the collection module 116, for example, during the past 1 day, 1 week, or 1 month. This can ensure that the determined thresholds account for any new techniques for obfuscating or anonymizing publisher identities. Additionally or alternatively, more accurate threshold values can be determined by calculating similarity metrics for multiple combinations (e.g., each possible combination) of publishers that are known to be the same.

In preferred examples, the ground truth data 132 database can store publisher IDs for each known publisher. These publisher IDs can be provided to the ground truth data 132 database by the processing module 118. For example, the processing module 118 can scan the data provided by the collection module 116 to identify any publisher IDs that have an unambiguous identification of the publisher. In the example shown in Table 1, publisher IDs “Def,” “Ghi,” and “Pqr” are associated with known publishers “A,” “A,” and “B,” respectively. These associations or mappings can be provided by the processing module 118 to the ground truth data 132 database. The learning module 120 can then use the mappings to identify appropriate publisher ID combinations to use for determining thresholds. For example, given that publisher IDs “Def” and “Ghi” are both associated with the same known publisher (publisher “A”), the learning module 120 can determine thresholds based similarity metrics for these two publisher IDs. In some examples, publishers “A” and “B” can be the publisher A module 126 and the publisher B module 128, respectively.

Next, the discovery module 122 can use the determined thresholds to infer the identities of any unknown or anonymized publishers. To accomplish this, the discovery module can apply ground truth mappings from the ground truth data 132 database to various combinations of publisher IDs. For example, the discovery module can determine if one or more similarity metrics for a combination of a known publisher and an unknown publisher exceed the determined threshold values. When the threshold values are exceeded, the discovery module 122 can conclude that the known publisher and the unknown publisher are the same. For example, referring again to Table 1, the discovery module 122 can determine if a similarity metric for a combination of publisher IDs “Abc” (for an unknown publisher) and “Def” (for known publisher “A”) exceeds the threshold value. If the threshold value is exceeded, the discovery module 122 can conclude that these two publisher IDs are associated with the same publisher (publisher “A”). In some examples, such conclusions can be drawn when the threshold value is associated with a sufficiently high confidence level (e.g., 75%, 90%, or higher). Once a publisher has been identified in this manner, the discovery module 122 can map the publisher to the publisher ID and provide the mapping to the inferred data 134 database. This way, the discovery module 122 or other system components can retrieve and use the mapping to identify the publisher the next time the publisher ID appears in a content presentation record. The discovery module 122 can analyze additional combinations of known and unknown publishers in this manner. Any new, inferred mappings between publishers and publisher IDs can be added to the inferred data 134 database.

Additionally or alternatively, the discovery module 122 can analyze similarity metrics for pairs of unknown publishers. Referring again to Table 1, for example, one or more similarity metrics can be calculated for the two unknown publishers having publisher IDs “Jkl” and “Mno.” When the similarity metrics exceed a corresponding threshold, the two publishers can be determined to be the same. Without additional information, it may not be possible to infer the true identity of either publisher; however, such a determination can be informative for optimizing future content presentations, as described herein.

Next, the analysis module 124 can analyze the mappings of publishers to publisher IDs from the ground truth data 132 database and/or the inferred data 134 database to determine if any future content presentations should be adjusted. For example, the mappings can reveal that multiple publishers are presenting similar or identical content to a group of client devices. The analysis module 124 can conclude, based on these mappings, that there are too many redundant content presentations. In response, the analysis module 124 can facilitate an adjustment to the content presentations (step 206). The analysis module 124 can, for example, stop using one or more of the publishers to present the content. Additionally or alternatively, the analysis module 124 may conclude that there is an insufficient number of publishers providing content to a group of client devices. In that case, the analysis module 124 can increase the number of publishers that are providing content to the group.

In some examples, the analysis module 124 can receive the calculated similarity metrics and/or the publisher ID mappings and generate a recommendation report with proposed adjustments to future content presentations. The recommendations can be based on situations where content is being presented by the same publisher. In some instances, for example, content presented by the same publisher can have a pricing that depends on the publisher ID used by the publisher. In that case, the analysis module 124 can recommend that presentations for the more expensive publisher ID be reduced or eliminated.

In various examples, the systems and methods described herein can utilize batch processing. For example, the system 100 can be run on a daily, weekly, or monthly basis, using the most recent historical data. Any new inferred publishers can be incrementally written to the inferred data 134 database, thereby growing the collection of publisher mappings data.

To extract actionable insights from big data, it can be important in some examples to leverage big data technologies, so that there is sufficient support for processing large volumes of data. Examples of big data technologies that can be used with the systems and methods described herein include, but are not limited to, APACHE HIVE and APACHE SPARK. In general, APACHE HIVE is an open source data warehousing infrastructure built on top of HADOOP for providing data summarization, query, and analysis. APACHE HIVE can be used, for example, as part of the processing module 118. APACHE SPARK is, in general, an open source processing engine built around speed, ease of use, and sophisticated analytics. APACHE SPARK can be used to calculate and analyze similarity metrics and thresholds in a scalable and timely manner. APACHE SPARK can be used, for example, as part of the processing module 118. In general, the capabilities of the systems and methods described herein can be achieved or implemented using APACHE SPARK or other suitable real-time platforms that are capable of processing large volumes of real-time data.

Advantageously, the system 100 is modular and can be expanded to calculate and utilize similarity metrics for new parameters (e.g., in addition to device ID, IP address, and the like) or combinations thereof. This allows development of new algorithms for ensemble learning that can measure impactful similarity statistics of metrics and calculate statistical thresholds in a swift and independent manner.

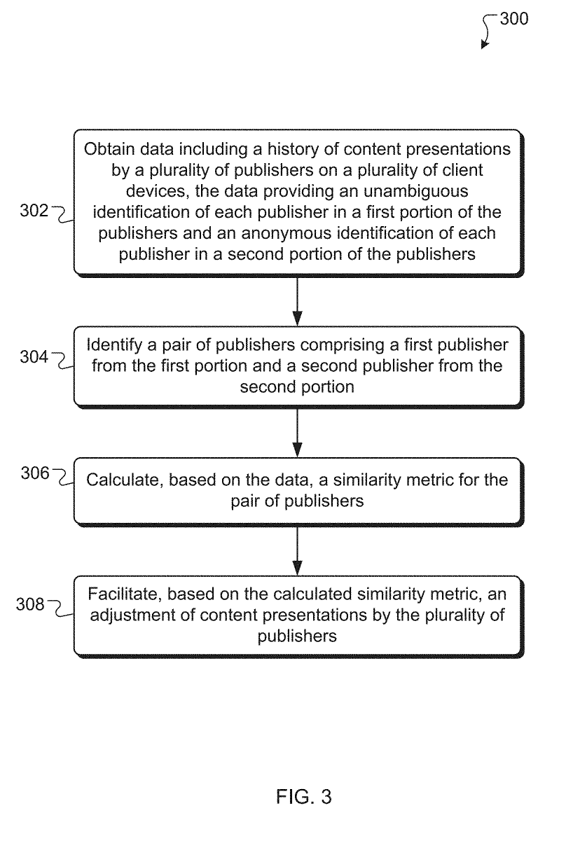

FIG. 3 illustrates an example computer-implemented method 300 of inferring anonymized publishers and managing digital content presentations. Data is obtained (step 302) that includes a history of content presentations by a plurality of publishers on a plurality of client devices. The data provides an unambiguous identification of each publisher in a first portion of the publishers and an anonymous identification of each publisher in a second portion of the publishers. A pair of publishers is identified (step 304) that includes a first publisher from the first portion and a second publisher from the second portion. Based on the data, a similarity metric is calculated (step 306) for the pair of publishers. Based on the calculated similarity metric, an adjustment of content presentations by the plurality of publishers is facilitated (step 308).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
obtaining data comprising a history of content presentations by a plurality of publishers on a plurality of client devices, the data providing an unambiguous identification of each publisher in a first portion of the publishers and an anonymous identification of each publisher in a second portion of the publishers;
identifying a pair of publishers comprising a first publisher from the first portion and a second publisher from the second portion;
calculating, based on the data, a similarity metric for the pair of publishers; and
facilitating, based on the calculated similarity metric, an adjustment of content presentations by the plurality of publishers.

2. The method of claim 1, wherein the data comprises a client device identifier and a timestamp for each content presentation.

3. The method of claim 1, wherein each publisher comprises one of a website and a software application.

4. The method of claim 1, wherein the unambiguous identification comprises a publisher name.

5. The method of claim 1, wherein the anonymous identification comprises an anonymized publisher identifier.

6. The method of claim 1, wherein calculating the similarity metric comprises:
determining a degree of overlap between the first publisher and the second publisher for at least one parameter.

7. The method of claim 1, wherein calculating the similarity metric comprises:
calculating a plurality of similarity metrics by determining a degree of overlap between the first publisher and the second publisher for each parameter from a plurality of parameters;
determining a weight for each calculated similarity metric; and
weighing each similarity metric according to the determined weights.

8. The method of claim 1, wherein calculating the similarity metric comprises:
calculating a corresponding similarity metric for two publishers from the first portion of publishers;
determining a threshold value based on the corresponding similarity metric; and
comparing the similarity metric for the pair of publishers with the threshold value.

9. The method of claim 1, wherein calculating the similarity metric comprises:
determining, based on the similarity metric, that the first and second publishers are identical.

10. The method of claim 1, further comprising:
calculating a corresponding similarity metric for two publishers from the second portion of publishers,
wherein the facilitated adjustment is based at least in part on the corresponding similarity metric.

11. A system, comprising:
one or more computer processors programmed to perform operations comprising:
obtaining data comprising a history of content presentations by a plurality of publishers on a plurality of client devices, the data providing an unambiguous identification of each publisher in a first portion of the publishers and an anonymous identification of each publisher in a second portion of the publishers;
identifying a pair of publishers comprising a first publisher from the first portion and a second publisher from the second portion;
calculating, based on the data, a similarity metric for the pair of publishers; and
facilitating, based on the calculated similarity metric, an adjustment of content presentations by the plurality of publishers.

12. The system of claim 11, wherein the data comprises a client device identifier and a timestamp for each content presentation.

13. The system of claim 11, wherein the unambiguous identification comprises a publisher name.

14. The system of claim 11, wherein the anonymous identification comprises an anonymized publisher identifier.

15. The system of claim 11, wherein calculating the similarity metric comprises:
determining a degree of overlap between the first publisher and the second publisher for at least one parameter.

16. The system of claim 11, wherein calculating the similarity metric comprises:
calculating a plurality of similarity metrics by determining a degree of overlap between the first publisher and the second publisher for each parameter from a plurality of parameters;
determining a weight for each calculated similarity metric; and
weighing each similarity metric according to the determined weights.

17. The system of claim 11, wherein calculating the similarity metric comprises:
calculating a corresponding similarity metric for two publishers from the first portion of publishers;
determining a threshold value based on the corresponding similarity metric; and
comparing the similarity metric for the pair of publishers with the threshold value.

18. The system of claim 11, wherein calculating the similarity metric comprises:
determining, based on the similarity metric, that the first and second publishers are identical.

19. The system of claim 11, further comprising:
calculating a corresponding similarity metric for two publishers from the second portion of publishers,
wherein the facilitated adjustment is based at least in part on the corresponding similarity metric.

20. An article, comprising:
a non-transitory computer-readable medium having instructions stored thereon that, when executed by one or more computer processors, cause the computer processors to perform operations comprising:
obtaining data comprising a history of content presentations by a plurality of publishers on a plurality of client devices, the data providing an unambiguous identification of each publisher in a first portion of the publishers and an anonymous identification of each publisher in a second portion of the publishers;
identifying a pair of publishers comprising a first publisher from the first portion and a second publisher from the second portion;
calculating, based on the data, a similarity metric for the pair of publishers; and
facilitating, based on the calculated similarity metric, an adjustment of content presentations by the plurality of publishers.
